(19) United States
(12) Patent Application Publication
(10) Pub. No.: US 2024/0386781 A1
(43) Pub. Date: Nov. 21, 2024

(54) GAMING MACHINE AND METHOD WITH SYMBOL PORTING FEATURE

(71) Applicant: LNW Gaming, Inc., Las Vegas, NV (US)

(72) Inventors: Jamie KNIGHT, Henderson, NV (US); Aleksiya PETROVA, Las Vegas, NV (US)

(21) Appl. No.: 18/660,564

(22) Filed: May 10, 2024

Related U.S. Application Data
(60) Provisional application No. 63/502,980, filed on May 18, 2023.

(51) Int. Cl. G07F 17/32; G07F 17/34

(52) U.S. Cl. CPC G07F 17/3267; G07F 17/3211; G07F 17/34

(57) ABSTRACT

There is provided a gaming system, gaming machine, and method that utilize an electronic display device configured to display a plurality of symbol-bearing reels and an indicator bearing a pay multiplier. For each spin outcome, the reels are spun and stopped to land symbols in an array. In response to a triggering event, a location is designated as a sending portal and a second location is designated as a receiving portal. If a predetermined symbol or type of symbol lands in the sending portal, it will be copied to the receiving portal. The receiving portal may be in the same or another array and, if in another array, may or may not be located in a corresponding position of the other array. An aspect of the copied symbol is modified as part of the transfer operation.

### CROSS-REFERENCE TO RELATED APPLICATION(S)

This patent application claims priority benefit of U.S. Provisional Patent Application No. 63/502,980 filed May 18, 2023. The disclosure of the 63/502,980 Application is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc.

### FIELD OF THE INVENTION

The present invention relates to a technological improvement to gaming systems, gaming machines, and methods and, more particularly, to new and improved animations in connection with a symbol porting feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to an embodiment of the present invention, there is provided a gaming system, gaming machine, and method that utilize an electronic display device configured to display a plurality of symbol-bearing reels including one or more value-bearing symbols. For each spin outcome, the reels are spun and stopped to land symbols in an array. In response to a triggering event, a location in the array is designated as a sending portal and a second location is designated as a receiving portal. If a predetermined symbol or type of symbol (a “portable symbol”) lands in the sending portal, it will be copied to the receiving portal. The receiving portal may be in the same or another array and, if in another array, may or may not be located in a corresponding portal position of the other array. An aspect of the ported (copied) symbol may be modified as part of the transfer operation, for example, a value borne by the ported symbol may be multiplied.

Alternate embodiments may include other triggering events for the creation of portals, mixed types of symbols (e.g., credit value-bearing symbols, wild symbols) may be transferred via the portals, the location of the receiving portal may be random or somehow related to the location of sending portal, etc.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIGS. 3A-3B is a flowchart for a data processing method that corresponds to instructions executed by a controller, according to an embodiment of the present invention.

FIGS. 4 through 17 depict an illustrative series of game images that illustrate various aspects of the data processing method.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

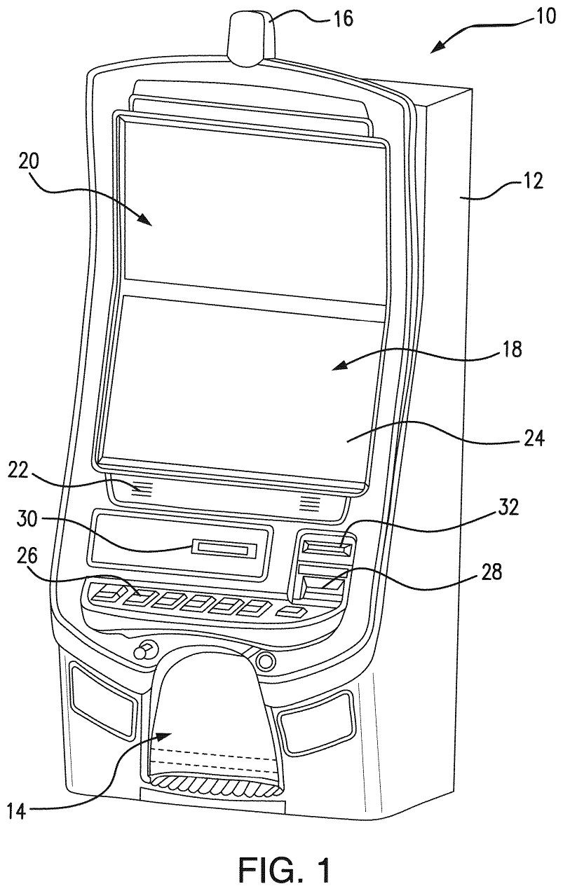

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

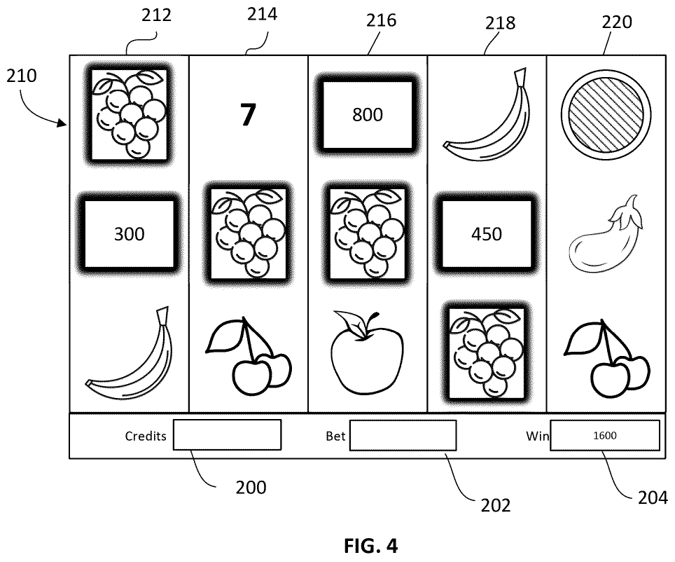

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIGS. 4-7). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIGS. 4-7), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

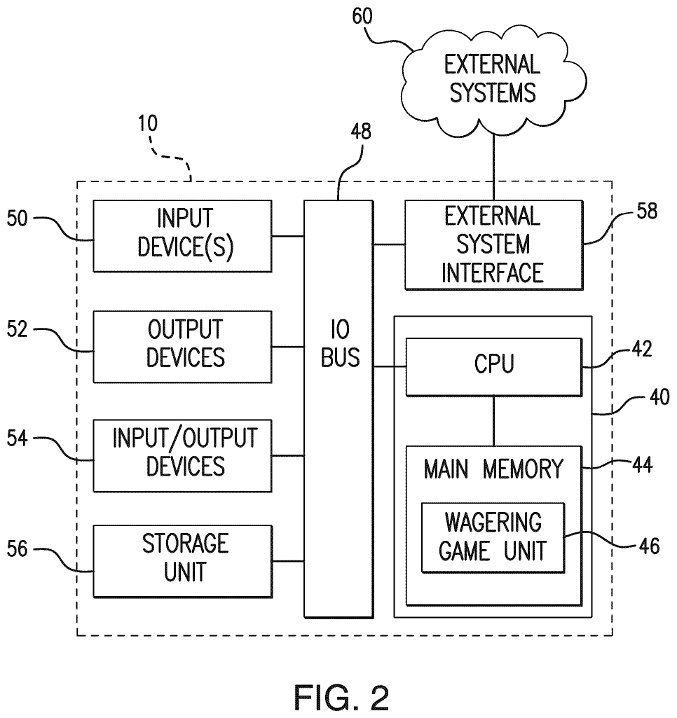

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40-whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

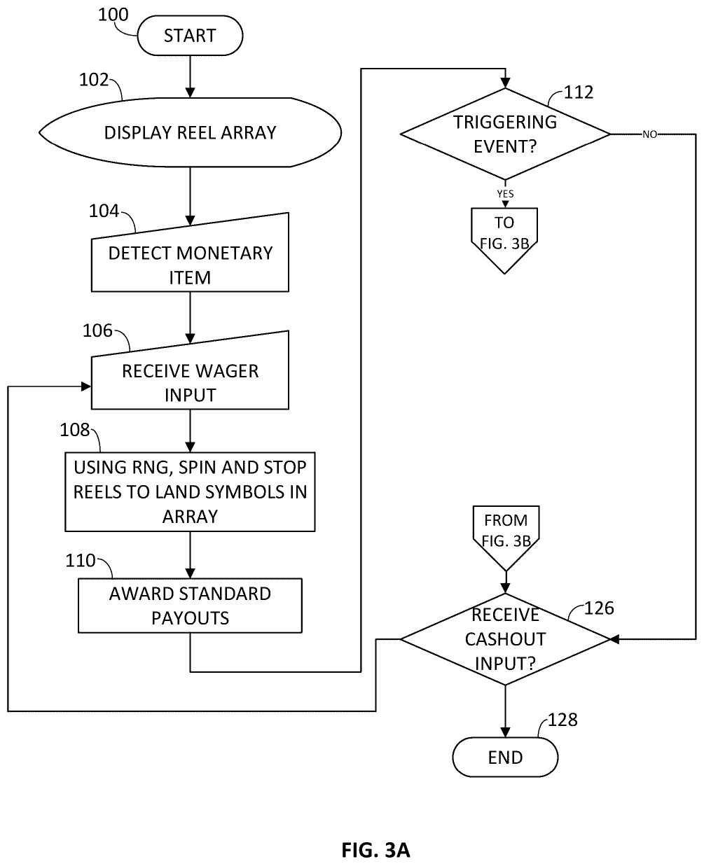

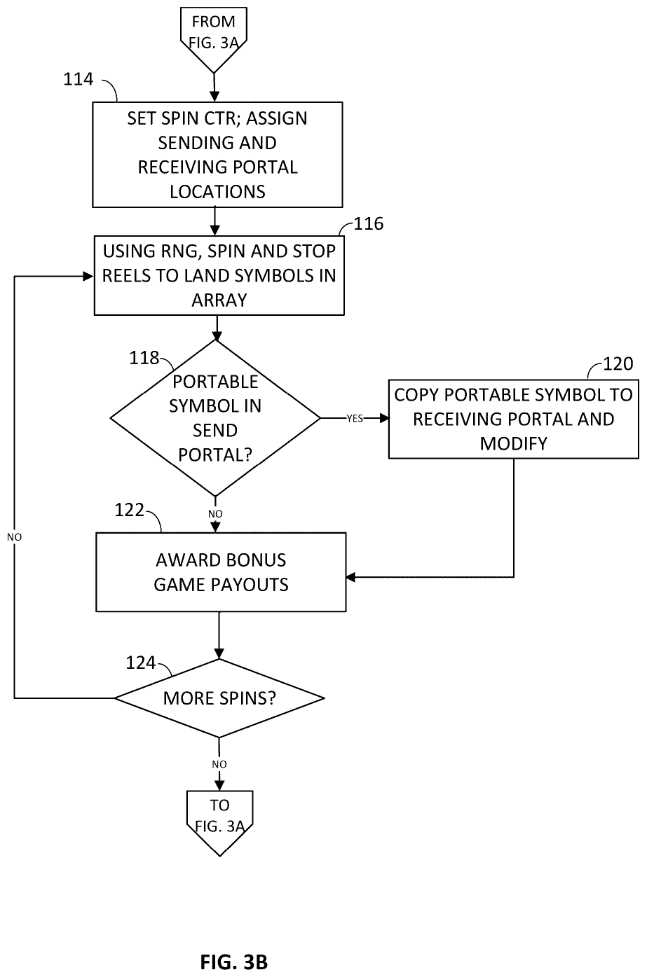

Referring now to FIGS. 3A and 3B, there is shown a flowchart representing one data processing method corresponding to at least some instructions stored and executed by the game-logic circuitry 40 in FIG. 2 to perform operations according to an embodiment of the present invention. The data processing method commences at step 100.

At step 102, the game-logic circuitry directs an electronic display device (e.g., video display) of the gaming machine to display a plurality of symbol-bearing reels and an array of symbol positions. The array of symbol positions comprises a plurality of rows and columns. The rows of the array are oriented in a horizontal direction, and the columns of the array are oriented in a generally vertical direction. Alternatively, the “rows” of the array may be oriented in a vertical direction, and the “columns” of the array may be oriented in a horizontal direction. The symbol positions in each row of the array are horizontally aligned with each other, and the symbol positions in each column of the array are vertically aligned with each other. The reels may be associated with the respective columns of the array such that the reels spin vertically and each reel populates a respective column. The reel spin is animated by depicting symbol-bearing strips moving vertically across the display and synchronously updating the symbols visible on each strip as the strip moves across the display. In another embodiment, the reels may be associated with the respective rows of the array such that the reels spin horizontally and each reel populates a respective row. In yet another embodiment, the reels may be associated with respective individual symbol positions of the array such that each reel populates only its respective symbol position. In the example shown in FIG. 4, the electronic display device displays five symbol-bearing reels 212, 214, 216, 218, 220 arranged from left to right and associated with respective columns of a 3×5 array 210 that includes three rows and five columns.

At step 104, the game-logic circuitry detects, via at least one of one or more electronic input devices, a physical item associated with a monetary value that establishes a credit balance. As shown in FIG. 4, the credit balance may be shown on a credit meter 200 of the gaming machine.

At step 106, the game-logic circuitry initiates a wagering game cycle in response to an input indicative of a wager covered by the credit balance. To initiate a spin of the reels, the player may press a “Spin” or “Max Bet” key on a button panel or touch screen. As shown in FIG. 4, the wagered amount may be shown on a bet meter 202 of the gaming machine.

At step 108, using an RNG, the game-logic circuitry spins and stops the plurality of symbol-bearing reels to randomly land symbols from the reels in the array in visual association with one or more paylines (also known as lines, ways, patterns, or arrangements). The game-logic circuitry is configured to evaluate the displayed array of symbols and provides immediate awards and bonus games in accordance with a pay table. The pay table may, for example, include “line pays” and “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus games based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array. Each payline preferably consists of a single symbol position in each column of the array. The number of paylines may be as few as one or as many as possible given each payline consists of a single symbol position in each column of the array. In a 3×5 array with three rows and five columns, the maximum number of such paylines is 35=243 lines.

In accordance with the data processing method in FIG. 3, FIGS. 4-14 depict illustrative alternate spin outcomes associated with a series of game cycles. The game images illustrate aspects of the data processing method. Each game image is associated with a different game cycle (or a different stage of a same game cycle) and represents an illustration of a spin outcome, i.e., in response to a wager or as part of a free spin, the reels 212, 214, 216, 218, 220 have been spun and stopped to populate the array 210 with symbols. In the game images, the standard symbols are GRAPE, APPLE, CHERRY, BANANA, WATERMELON, EGGPLANT, and SEVEN. The value-bearing symbols are represented as an ENVELOPE (which looks like a rectangle) and are “portable symbols.” The game images also include a special PORTAL symbol (which looks like a circular porthole). In this illustrated series of game cycles, standard pays occur when three or more matching standard symbols appear on adjacent reels along an active payline starting from the leftmost reel 212. For example, FIG. 4 illustrates the reels 212, 214, 216, 218, 220 after they have been spun and stopped to randomly populate the array 210 with symbols from the reels.

At step 110, the game-logic circuitry awards payouts for any standard pays (e.g., line pays and scatter pays) as determined by the game's pay table. In the example of FIG. 4, the GRAPE symbols on reels 212, 214, 216 and 218 represent a winning combination and are, thus, highlighted. The total awards from all standard winning combinations are added to a win meter 204 of the gaming machine. In addition, the game-logic circuitry awards the values borne by any value-bearing ENVELOPE symbols (e.g., the three symbols bearing the credit values 300, 800, and 450 in FIG. 4). The summed awarded values, in this example, 1550 credits, are also added to the win meter 204 shown in FIG. 4. To communicate which game elements contribute to payouts and how they contribute, the game-logic circuitry may direct the electronic display device to animate paying symbols, symbol positions and award amounts. The animation may, for example, include applying a border, pattern, color change, background change, watermark, or other distinguishing characteristic to the paying symbols and/or their symbol positions.

In one or more alternate embodiments, the symbol porting concepts disclosed herein may apply to a base game, a bonus game, or both. The method illustrated here describes a base game and a bonus game triggered during play of the underlying base game, thus, at step 112, the game-logic circuitry determines whether or not a bonus game has been triggered in response to a triggering event. The triggering event may be the landing of one or more particular “triggering” symbols landing in the array, a certain winning combination of symbols landing in the array, a “mystery” trigger randomly determined by the game-logic circuitry via the RNG, etc. In this example, the PORTAL symbol acts as a triggering symbol.

If no triggering event is detected at step 112, the game-logic circuitry proceeds to step 126, described below. However, in this example, the PORTAL symbol on the fifth reel 120 landing in the array triggers the initiation of a bonus game and flow proceeds to step 114 in FIG. 3B.

As shown here, the bonus game may be a series of free spins utilizing steps 114 through 124 of the method in FIG. 3B. The number of free spins may be fixed or variable, but in the illustrated embodiment, when the bonus game commences, a spin counter may be initialized to an initial value, such as three, at step 114.

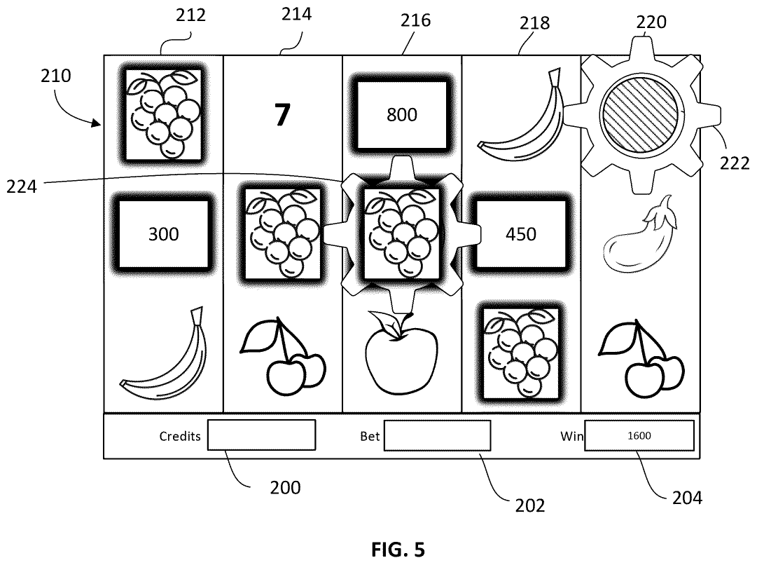

Also at step 114, the game-logic circuitry designates a location in the array as a sending portal. In the example of FIG. 5, the sending portal 222 is designated as the array location in which the PORTAL symbol landed, but the sending portal may be placed elsewhere in the array, for example, in the center location in the second row of reel 216.

Similarly, also at step 114, the game-logic circuitry designates a location in the array as a receiving portal. The receiving portal may be designated at any array location other than the location of the sending portal. In the example of FIG. 5, the receiving portal 224 is designated as the center location (i.e., the second row of reel 216).

The designation of the sending and receiving portals is preferably emphasized by presenting a new and improved animation on the electronic display device. For example, the display may apply a flashing border, pattern, color change, background change, watermark, or other distinguishing characteristic to the sending portal in the array or otherwise animate the designation of the sending portal. In the example of FIG. 5, the sending and receiving portals have been so designated by the addition of a “gear” background to their respective locations in the array.

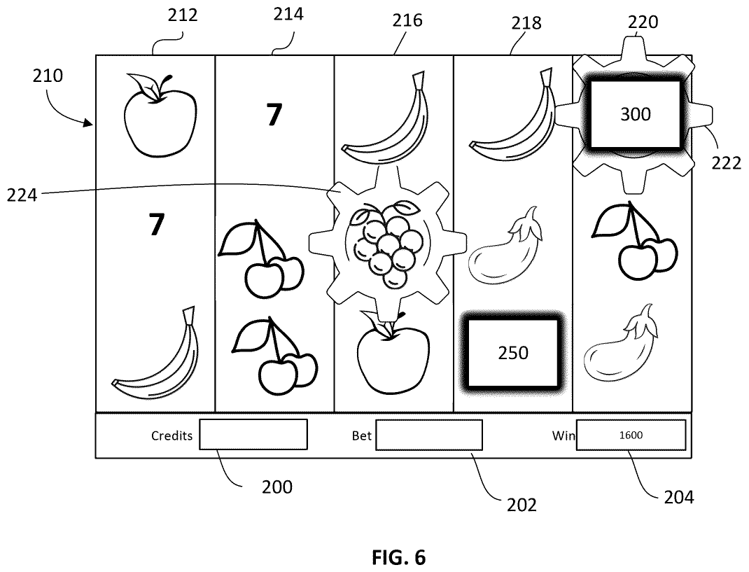

At step 116, using the RNG, the game-logic circuitry again spins and stops the plurality of symbol-bearing reels to randomly land symbols from the reels in the array as described above with respect to step 108. The example of FIG. 6 depicts one possible spin outcome of this step.

At step 118, the game-logic circuitry checks to see if any portable ENVELOPE symbols landed in the sending portal 222. If not, flow continues to step 122.

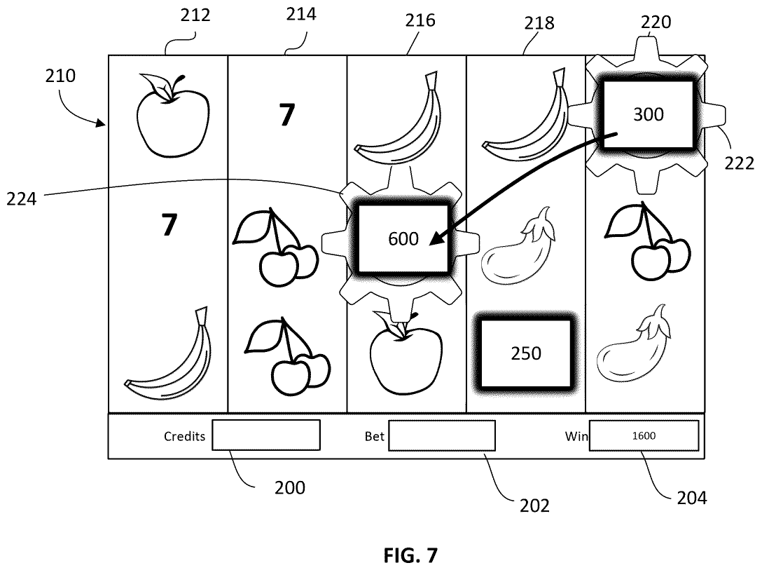

In the example of FIG. 6, an ENVELOPE bearing the value of 300 landed in the sending portal 222. In such a case, flow continues to step 120, where the ENVELOPE symbol is ported (copied) from the sending portal 222 to the receiving portal 224. The porting of the symbol from the sending portal to the receiving portal may be animated. For example, an animation like lightning or other special effect may extend between the sending portal 222 and the receiving portal 224 while a copy of the ENVELOPE symbol in the sending portal 222 may appear to move or “float” from the sending portal 224 to its new position in the receiving portal 224. FIG. 7 depicts the animation of the porting of the ENVELOPE from the sending portal 222 to the receiving portal 224 with an arrow extending from the sending portal 222 to the receiving portal 224.

Once ported, the ported symbol may be optionally modified at step 120. For example, its value may be multiplied by a predetermined or random factor. In the example of FIG. 7, the value of the ENVELOPE symbol is multiplied by two (from 300 to 600).

At step 122, as in step 110, the game-logic circuitry awards payouts for any winning combinations, which may be paid according to a paytable which may be different or the same as the standard base game paytable. Again, the values borne by any ENVELOPE symbols are paid. According to that paytable, the spin counter may be reset to its original value or otherwise modified whenever a symbol is ported or when another predetermined condition is met.

At step 124, the spin counter decrements after each free spin and is checked to see whether it is zero. In alternate embodiments, the spin counter may be initialized to 1 at step 114 and incremented at step 124 until reaching a predetermined limit. In still other embodiments, the duration of the bonus game may be timed. Any method for determining the number of free spins in the bonus game may be employed. Regardless of the method for terminating the bonus game, step 124 determines whether any free spins remain. If so, flow returns to step 116. Otherwise, the bonus game ends and flow continues to step 126 of FIG. 3A.

At step 126, the game-logic circuitry determines whether or not it has received a cashout input via at least one of the one or more player input devices of the gaming machine. If it has not received a cashout input, the game-logic circuitry waits for the next wager input at step 106. If it has received a cashout input, the game-logic circuitry initiates a payout from the credit balance on the credit meter such as the meter 200 in FIG. 4. The data processing method then ends at step 128.

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” or “example” means that the embodiment being referred to serves as a non-limiting example or illustration.

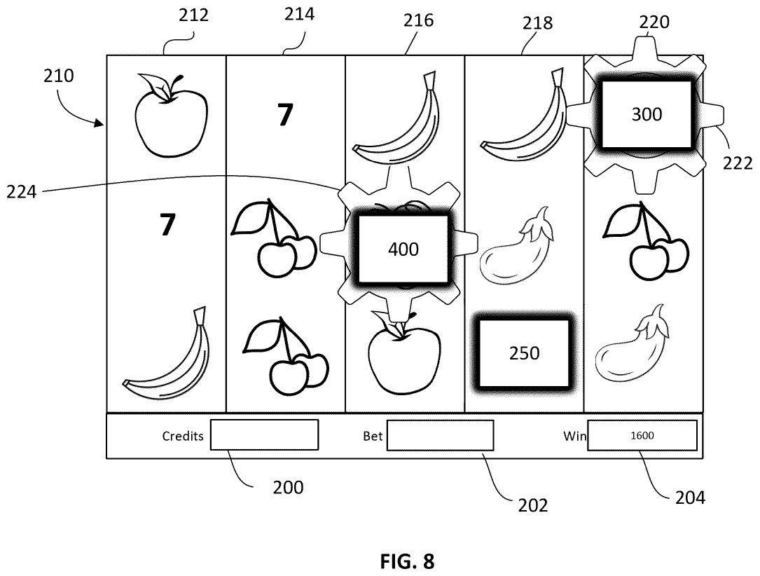

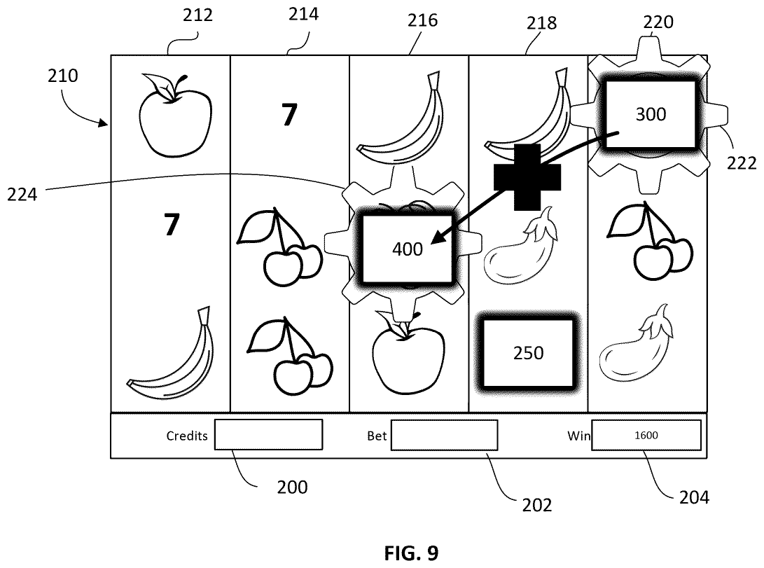

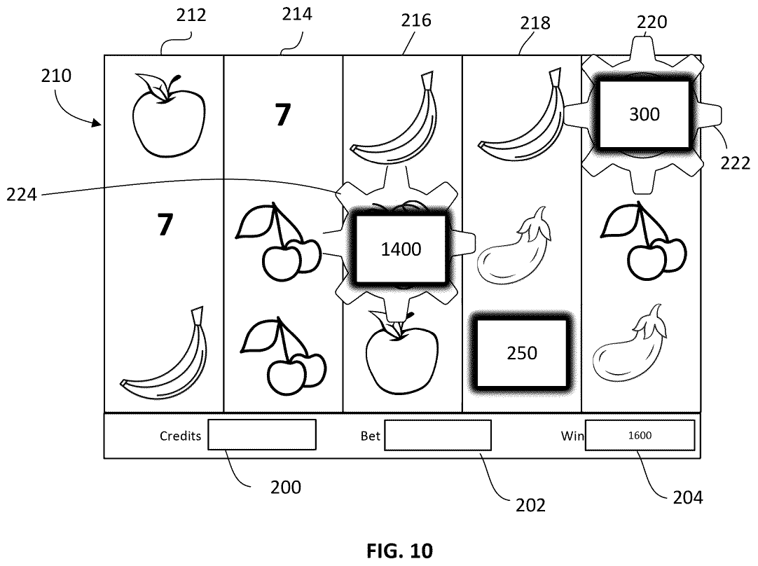

For example, FIGS. 8-10 depict an alternate spin outcome for step 116. In the example of FIG. 8, a value-bearing symbol bearing the value of 300 landed in the sending portal 222. However, a value-bearing symbol bearing the value of 400 also landed in the receiving portal 224. In such a case, the value borne by the symbol in the sending portal 222 may be added to the value borne by the symbol in the receiving portal 224 (i.e., 300+400=700). FIG. 9 depicts the animation of the porting of the value bearing symbol “300” from the sending portal 222 to the receiving portal 224 with an arrow extending from the sending portal 222 to the receiving portal 224 and a “+” sign symbolizing the addition of the values borne by the two symbols. As above, the ported value may then me further modified, for example, multiplied by two. FIG. 10 depicts the final result of step 120, showing the final value in the receiving portal 224 as 1400 (i.e., 700 times 2).

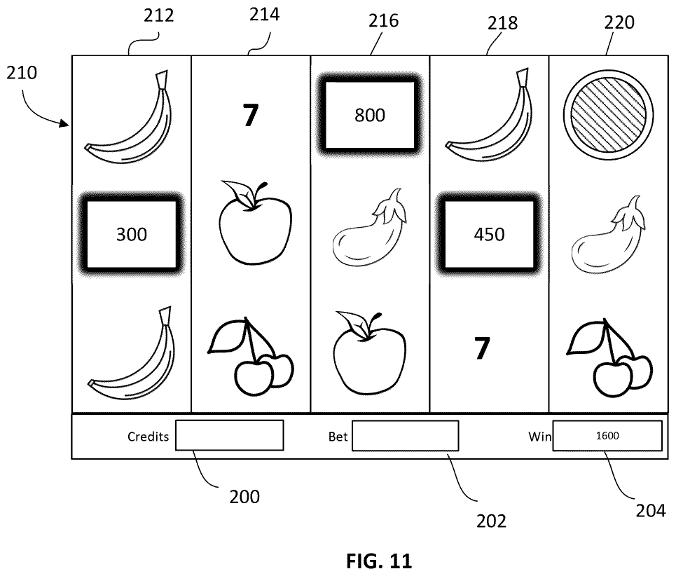

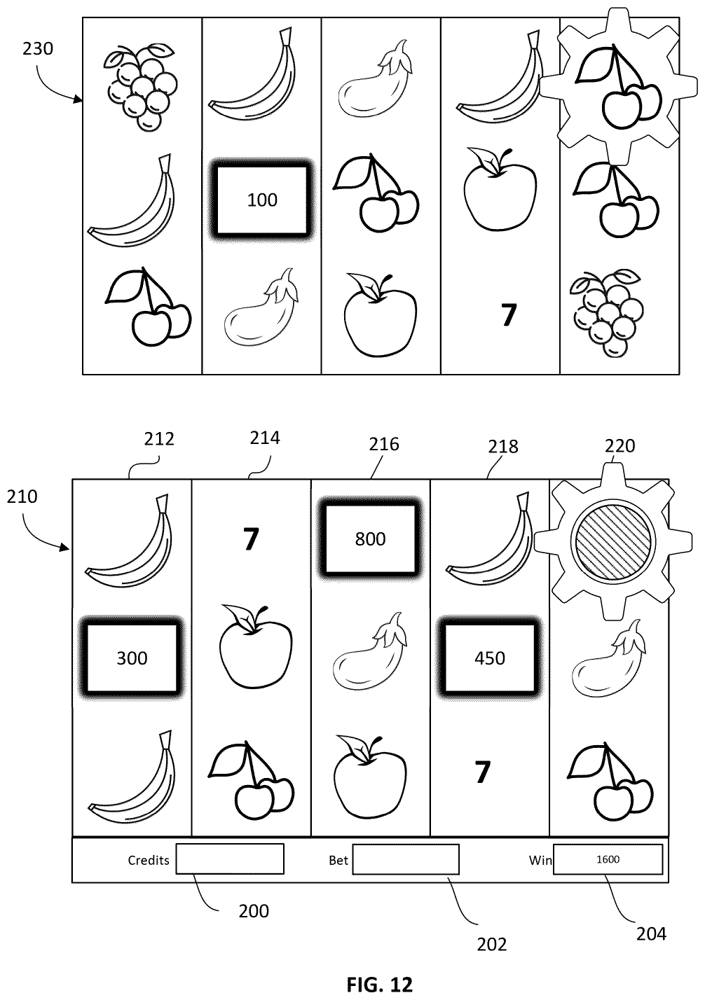

FIGS. 11-13 depict a preferred embodiment in which the triggering of the bonus game at step 112 generates a second array. Analogous to FIG. 4, the landing of the PORTAL symbol in array 210 of FIG. 11 triggers the bonus game. In this embodiment, as depicted by FIG. 12, a second array 230 is generated by the triggering of the bonus game. During the bonus game, steps 114-124 are followed as described above, but for both arrays. The location of the sending portal 222 is designated at the position in array 210 where the PORTAL symbol landed. In this embodiment, the location of the receiving portal 224 is designated at the corresponding position in the new bonus array 230. In other embodiments, the receiving portal may be placed elsewhere in array 230, for example, always in the center location of array 230 or at a randomly determined location.

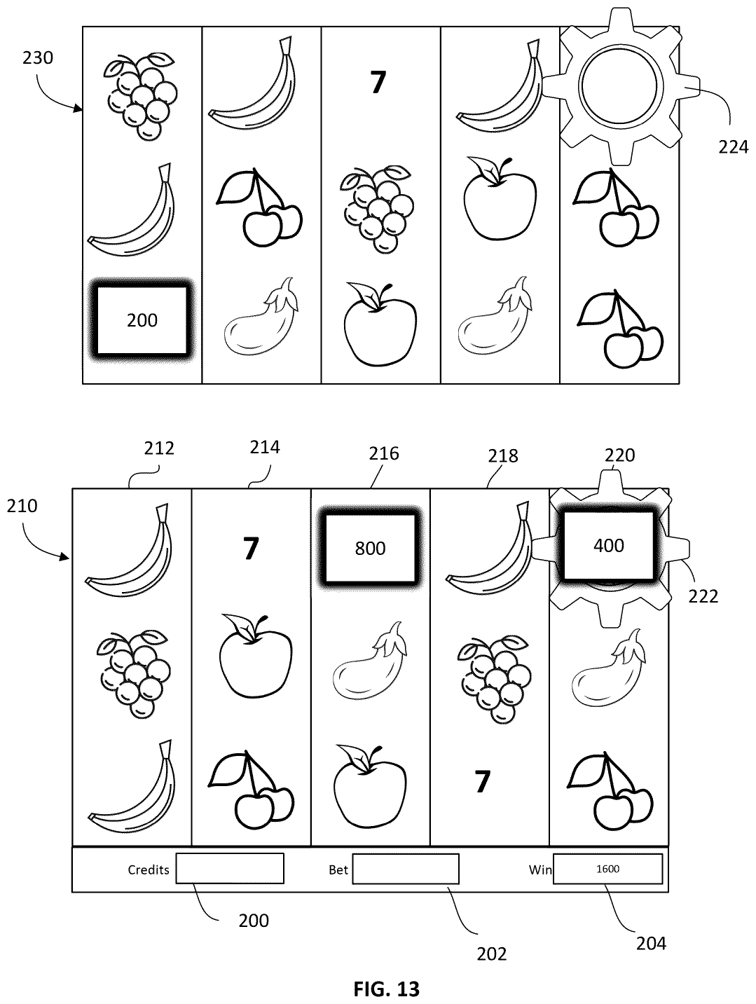

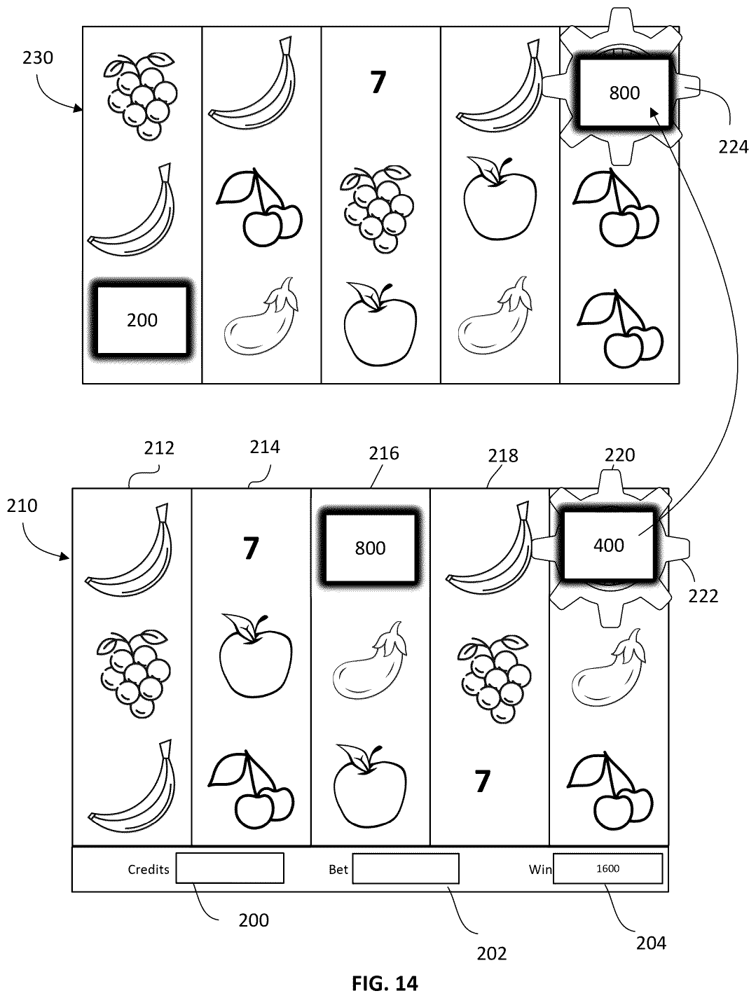

Following one or more free spins of the bonus game, FIG. 13 depicts an ENVELOPE symbol bearing the value 400 landing in the sending portal 222. FIG. 14 depicts the porting of this ENVELOPE symbol from the sending portal 222 to the receiving portal 224 and subsequent modification of its value from 400 to 800 according to the method described above.

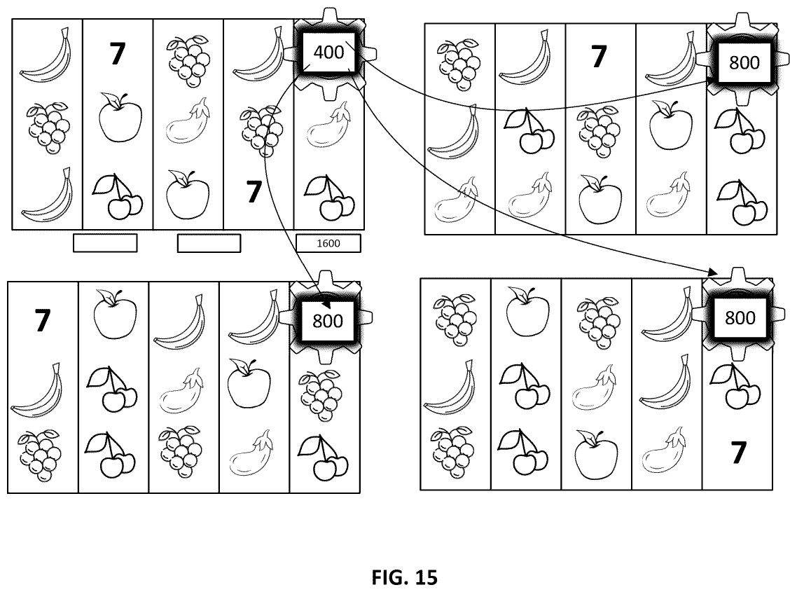

FIG. 15, in accordance with one or more alternate embodiments in which the base game creates multiple bonus game arrays and designates a receiving portal in each of the multiple bonus game arrays depicts porting an ENVELOPE symbol from the base game sending portal into multiple bonus game receiving portals.

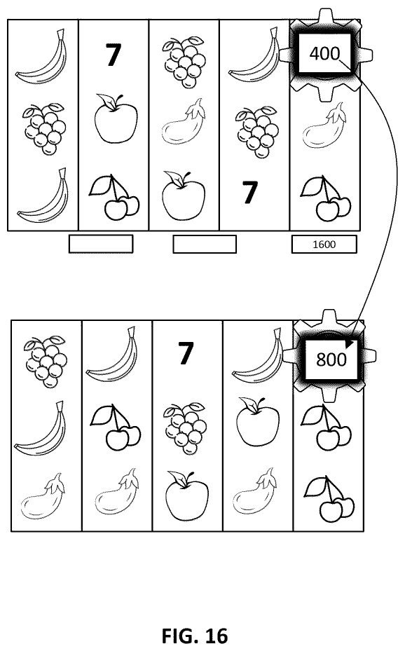

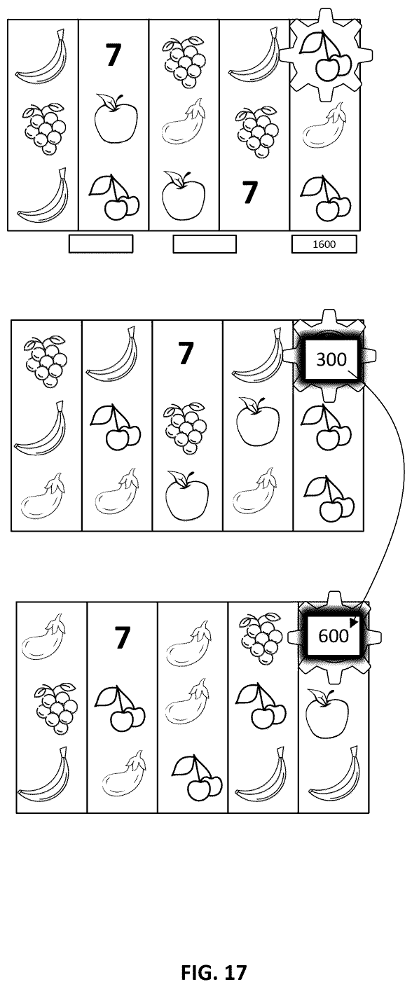

FIGS. 16-17, in accordance with one or more alternate embodiments in which the base game creates multiple a new bonus game array and designates a receiving portal in the bonus game array depicts porting an ENVELOPE symbol from the base game sending portal into the bonus game receiving portal. This is analogous to the example of FIGS. 11-13. However, in these embodiments, as illustrated by FIG. 16, once the receiving portal is designated in the second array, it may also serve as a second sending portal such that, when an ENVELOPE lands in the second sending portal, it generates a third array with a receiving portal and ports its ENVELOPE into the receiving portal in the third array. Thus, a portal may a sending portal, a receiving portal, or both, depending on whether an ENVELOPE lands in an established portal location or not.

In accordance with other embodiments, the modification of the ported symbols may take other forms. For example, the amount borne by the ported symbol may be added to, subtracted from, or randomly assigned a new value including a jackpot label such as MINI, MINOR, MAJOR and MEGA. In other examples, instead of being value-bearing symbols bearing credit amounts, the ported symbols may be wild symbols which may or may not bear a multiplier value. For example, a wild symbol (i.e., a symbol that act as a substitute for a standard symbol to complete a winning combination) with a 1× multiplier may be ported from a sending portal to a receiving portal, where it is modified to become a 2× wild symbol. In some embodiments, there may be mixed types of portable symbols. For example, portable symbols may include both credit-bearing symbols and wild symbols. When a portable symbol of either type lands in the sending portal 222, it is ported to the receiving portal 224, where it may or may not be modified before being used for win evaluation.

In the illustrated embodiments, triggering (PORTAL) symbols only exist on the fifth reel and must land in the array in order to trigger the bonus game and to establish new receiving portal locations. In an alternative embodiment, triggering symbols may exist on one or more other reels and may likewise trigger these operations by landing in the array. In a further example, if multiple PORTAL symbols land in the array in the same spin outcome, each landed PORTAL symbol may trigger the establishment of an associated sending and receiving portal. Thus, the array(s) may contain multiple sending and receiving portals. In some embodiments, a certain catalyst symbol, for example, a CLOSE PORTALS symbol, may remove the portals from the array, requiring a newly landed PORTAL symbol on a subsequent spin to establish a new set of sending and receiving portals.

In some embodiments, another type of catalyst symbol is included on one or more of the reels and must land in the array to trigger awarding of ENVELOPE values. This triggering may be animated. For example, the value borne by each ENVELOPE may be hidden unless an OPEN ENVELOPE also lands in the array, at which point an animation of the ENVELOPEs opening to reveal their respective values is presented on the electronic display device.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.CLAIMS:

What is claimed is:

1. A method of operating a gaming machine, the method comprising the operations of:
displaying, on an electronic display device, a plurality of symbol-bearing reels, the symbols borne by the symbol-bearing reels comprising basic symbols, trigger symbols and portable symbols; and
generating, by game-logic circuitry using a random number generator, a bonus game comprising a series of free spin outcomes, each spin outcome comprising:
spinning and stopping the plurality of symbol-bearing reels to populate a first array and a second array with landed symbols from the stopped reels;
in response to a triggering event:
designating a position in the first array as a sending portal and designating a position in the second array as a receiving portal; and
in response to one of the series of free spin outcomes comprising a portable symbol landing in the sending portal:
animating, on the electronic display device, moving a copy of the landed portable symbol from the sending portal to the receiving portal; and
modifying an aspect of the portable symbol in the receiving portal.

2. The method of claim 1, wherein the portable symbols comprise value-bearing symbols.

3. The method of claim 2, wherein the value-bearing symbols bear respective credit amounts.

4. The method of claim 2, wherein the value-bearing symbols bear respective multiplier amounts.

5. The method of claim 4, wherein the value-bearing symbols comprise wild symbols.

6. The method of claim 2, wherein the modified aspect comprises the value borne by the portable symbol in the receiving portal.

7. The method of claim 2, wherein the portable symbols comprise value-bearing symbols and wherein the modifying step comprises applying a multiplier to the value borne by the portable symbol in the receiving portal.

8. The method of claim 1, wherein the portable symbols comprise value-bearing symbols;
and wherein, in response to the second in the series of free spin outcomes comprising a portable symbol landing in both the sending portal and in the receiving portal, replacing the value borne by the portable symbol that landed in the receiving portal with the sum of the value of the portable symbol that landed in the sending portal and the value of the portable symbol that landed in the receiving portal.

9. The method of claim 1, wherein the triggering event comprises the first in the series of free spin outcomes comprising a trigger symbol landing in the first array.

10. The method of claim 1, further comprising:
detecting, via at least one of one or more electronic input devices, a physical item associated with a monetary value that establishes a credit balance; and
receiving, via at least one of the one or more electronic input devices, a cashout input that initiates a payout from the credit balance.

11. A gaming machine comprising:
a presentation assembly; and
game-logic circuitry configured to perform the operations of:
conducting a bonus game comprising a series of free spin outcomes, each spin outcome comprising:
directing the presentation assembly to present spinning and stopping a plurality of symbol-bearing reels to populate a first array and a second array with landed symbols from the stopped reels, the symbols borne by the symbol-bearing reels comprising basic symbols, trigger symbols and portable symbols; and
in response to an occurrence of a triggering event:
designating a position in the first array as a sending portal and designating a position in the second array as a receiving portal; and
in response to at least one in the series of free spin outcomes comprising a portable symbol landing in the sending portal:
directing the presentation assembly to animate moving a copy of the landed portable symbol from the sending portal to the receiving portal; and
modifying an aspect of the portable symbol in the receiving portal.

12. The gaming machine of claim 11, wherein the portable symbols comprise value-bearing symbols.

13. The gaming machine of claim 12, wherein the value-bearing symbols bear respective credit amounts.

14. The gaming machine of claim 12, wherein the value-bearing symbols bear respective multiplier amounts.

15. The gaming machine of claim 14, wherein the value-bearing symbols comprise wild symbols.

16. The gaming machine of claim 12, wherein the modified aspect comprises the value borne by the portable symbol in the receiving portal.

17. The gaming machine of claim 12, wherein the portable symbols comprise value-bearing symbols and wherein the game-logic circuitry is configured to perform the operation, in the modifying step, of applying a multiplier to the value borne by the portable symbol in the receiving portal.

18. The gaming machine of claim 11, wherein the portable symbols comprise value-bearing symbols; and wherein, in response to the second in the series of free spin outcomes comprising a portable symbol landing in both the sending portal and in the receiving portal, the game-logic circuitry is configured to perform the operation of replacing the value borne by the portable symbol that landed in the receiving portal with the sum of the value of the portable symbol that landed in the sending portal and the value of the portable symbol that landed in the receiving portal.

19. The gaming machine of claim 11, wherein the triggering event comprises the first in the series of free spin outcomes comprising a trigger symbol landing in the first array.

20. The gaming machine of claim 11, further comprising:
a value input device configured to receive a physical item associated with a monetary value that establishes a monetary balance; and
a value output device configured to dispense a payout from the monetary balance.
